(19) United States
(12) Patent Application Publication
(10) Pub. No.: US 2002/0083333 A1
(43) Pub. Date: Jun. 27, 2002

(54) Method and system for the secure use of a network serivce

(76) Inventors: Michael Frank, Muenchen (DE); Ralf Rieken, Reston, VA (US)

Correspondence Address: BELL, BOYD & LLOYD, LLC, P. O. BOX 1135, CHICAGO, IL, 60690-1135, US

(21) Appl. No.: 09/877,861

(22) Filed: Jun. 8, 2001

(30) Foreign Application Priority Data
Jun. 8, 2000 (DE) 100 283 49.7

(51) Int. Cl. H04L 9/00

(52) U.S. Cl. 713/200; 705/59

(57) ABSTRACT

A method and system for the secure use of a service, wherein the use software for a service is extended by at least one security function to form at least partially secure use software. The service is used using the extended use software. This provides secure use RMI of services, preferably in plug & play networks.

### BACKGROUND OF THE INVENTION

1. Field of the Invention

The present invention relates, generally, to a method and system for the secure of a network service and, more particularly, to such a method and system using a blackboard on which all usable services are entered and, upon detection of a service which has not yet been entered on the blackboard, a check is made to determine whether use of this service is admissible and, if so, the service is entered under the blackboard.

2. Description of the Prior Art

The extension of networks is usually administered centrally today. If a new network element is added, it is necessary to ensure that it “gets on” with the network elements which are already available; that is, a syntactically and semantically correct interface to the network is stipulated and appropriate interface drivers, also called “stubs,” are used. Stipulating such interfaces is usually time consuming and very susceptible to errors, particularly between systems from different manufacturers, because, for example, it is then usually possible to network together only interface drivers which are based on the same interface version.

One concept for a more flexible extension of networks is “Plug & Play (PnP),” where each network element specifies its interface using a specific interface description language, and services of the network element are accessed using interface drivers which are produced using the interface specification. An example of one application of the PnP concept is in “ad-hoc networks,” in which network elements from different manufacturers respectively make their services available to those network elements which are currently integrated in the ad-hoc network; there being no prior stipulation as to which interface is possessed by the respective network elements. A brief description of this novel network type can be found in Claudia Piemont, “Geistreiche Verbindungen—Intelligente Geräte in dezentralen Netzen” [Smart connections—Intelligent devices in local area networks], c't, No 20, 1998. Products in the PnP field are currently being developed at Sun (Jini™), Hewlett Packard (JetSend), Lucent (Inferno) or Microsoft (uPnP=Universal Plug & Playⁱ), for example. ⁱ cf. also http://www.upnp.org

The text below describes the Jini™ mechanisms from Sun by way of example. However, this constitutes no restriction for the inventive mechanisms, which can be used generally. The architecture and mechanisms of Jini™ are described in Sun Microsystems, “Jini™ Architectural Overview”, Technical White Paperⁱⁱ, 01/1999. Ad-hoc networks, such as that of Jini™, are distinguished in that network elements, and hence also the services they provide, can be added to and removed from a network arbitrarily. ⁱⁱ cf. also http://www.sun.com/jini/whitepapers/architecture.pdf

Services are understood as being an agency which can be used by a person, a program or another service. By way of example, they may be hardware, software, filters, a communication channel, memory space and much more. To deal with an overall object which is set, it may be necessary to use a large number of individual services. The services which are currently available and can thus be used in each case are registered on “blackboards,” sometimes, also called “lookup functions.”

The blackboards also control the addition and removal of services to and from the network at arbitrary times. Network elements are able to communicate, or “join,” their existence and their services to a blackboard. A blackboard is also able to search for network elements providing services, also called “lookup” or “discovery.” For use of the services, a leasing mechanism is provided. In this context, a period for use is agreed between the agencies involved, after the expiration of which the resources of the used service are released again. The use of services, and hence the communication which is necessary in this regard, is effected using Java Remote Method Invocation (RMI™), for example, the structure of which is comparable with the tried and tested Remote Procedure Calls (RPC).

The Jini security architecture is designed such that each service has an owner and is equipped with access control; i.e., the service has the identity of its owner. This owner generally also defines the system's use rights, at least for those services which it makes available to the system. If a first service now uses a second service, this use takes place with the identity of the second service. Whether access is permitted depends on the access control of the first service. In this regard, cf. also Richard Sietmann, “Jini organisiert das Netz selbst” [Jini organizes the network itself], Funkschau, No 23, page 84, section “Sicherheit bei Jini” [Jini security], 1 st paragraph, 1998. This concept requires local administration of use rights. In addition, a service for which no access control is provided is available to all the network elements in an ad-hoc network.

The present invention is thus directed to improving the secure use of a network service.

### SUMMARY OF THE INVENTION

Accordingly, a fundamental aspect of the present invention is secure use of a service with use software, where the use software is extended by at least one security function to form at least partially secure use software, and where the service is used using the extended use software.

A few fundamental advantages of the present invention are:

The producer of the use software need provide only the access functions to the extent that they are required for use of the service as such. The extension software for the security function can be produced by independent third parties.

In principle, access control is also provided for those services for which no individual access control was originally implemented.

It ensures that there is no unauthorized use of the service; e.g., by interface calls copied or manipulated by unauthorized third parties.

In accordance with one embodiment of the inventive method, the extension is made by an extension function associated with the blackboard. Hence, the central character of the blackboard requires that a homogeneous and consistent check be advantageously carried out within the scope of action of a blackboard, provided that uniform security functions are used for the extension.

In accordance with another embodiment of the inventive method, the extended use software is stored on a blackboard from which it is loaded by a service user at least before he/she uses the service for the first time. Advantageously, the service user's loading of the use software, also called “interface driver,” allows the installation of a service-specific interface driver for using the service to be dispensed with. The problems described initially are, thus, also eliminated.

In accordance with another embodiment of the inventive method, storage on the blackboard is effected only if a check reveals that storage is admissible.

In accordance with yet another embodiment of the inventive method, the check includes authentication and/or authorization of a service provider providing the service and/or the use software. Hence, services which cannot be used, no longer appear on the blackboard, which therefore becomes clearer. In addition, a homogeneous and consistent check can be carried out with comparatively little complexity within the scope of action of a blackboard, provided that the data required for this check are administered centrally.

In accordance with a further embodiment of the inventive method, the extension is made if the check reveals that use of the service is admissible. As such, the extension is made only if it is required, which avoids unnecessary extensions. This increases the efficiency of the blackboard.

In accordance with another embodiment of the inventive method, the use software and/or the extended use software has a format which is executed by a virtual machine. The possibly extended use software can then be used on any network element on which a virtual machine version designed for the network element is installed. The use software thus becomes independent of the specific design of the respective network elements.

In accordance with another embodiment of the inventive method, the security function includes at least the authentication and/or the authorization.

In accordance with yet another embodiment of the inventive method, in the context of the security function, the authentication checks the identity of the service user, and the authorization checks the entitlements of the service user. This prevents unauthorized use and use when a false identity is simulated.

In accordance with a further embodiment of the inventive method, in the context of the authorization, different groups of service users having different use entitlements are provided. This advantageously allows use of the service to be administered on the basis of the user groups; e.g., usually found in organizations.

In accordance with yet another embodiment of the inventive method, the security function is carried out whenever the service is used. As such, even after the use software has been loaded by the service user, the use of the service in the service user's network element is advantageously protected, including independently of the blackboard.

Additional features and advantages of the present invention are described in, and will be apparent from, the following Detailed Description of the Preferred Embodiments and the Drawings.

### DESCRIPTION OF THE DRAWINGS

FIG. 1 shows a schematic diagram of a communications system to which the method of the present invention is directed.

### DETAILED DESCRIPTION OF THE PREFERRED EMBODIMENTS

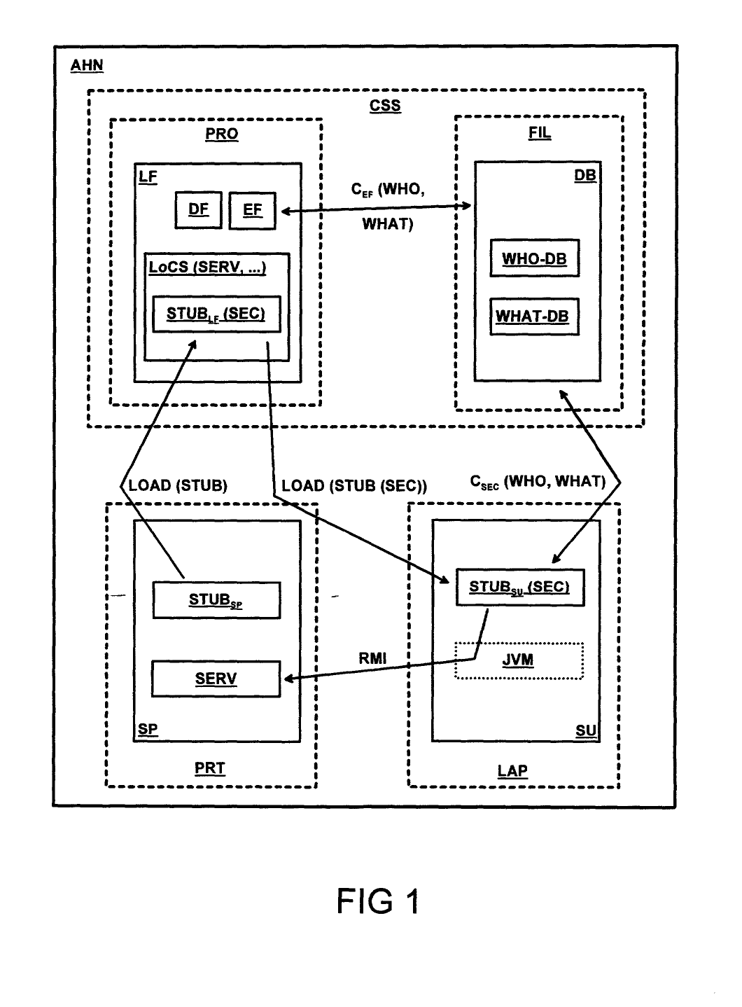

The system of FIG. 1 includes:

a service provider SP with a service SERV which can be used in principle, and use software STUB_{SP} for interface-compliant use RMI of the service SERV;

a blackboard LF with a discovery function DF for detecting services SERV which can be used in principle, an extension function EF for extending loaded use software STUB for a service SERV by a security function SEC, and a list of admissible services LoCS in which the service SERV is registered and its use software STUB_{LF}, possibly complemented by a security function SEC, is stored;

a service user SU with a loaded agency for the complemented use software STUB_{SU} (SEC) executed by a virtual machine JVM; and

a database DB storing an authentication database WHO-DB and an authorization database WHAT-DB.

To illustrate one possible system for carrying out the method of the present invention being embedded in a physical environment, FIG. 1 shows the service provider SP in the form of a printer PRT, the service user SU in the form of a laptop LAP, and the blackboard LF in the form of a process PRO running, by way of example, on a central security server ZSS in the ad-hoc network AHN. The database DB is integrated into the context of the process PRO, for example, by virtue of its being provided as a file FIL on the hard disk of the security server ZSS. The aforementioned physical devices, also called “network elements,” form an ad-hoc network AHN.

For one exemplary embodiment of the present invention, it may be assumed that the service SERV is to be used by the service user SU. To this end, the service user SU is spontaneously connected to the service provider SP in the ad-hoc network AHN, in which at least the blackboard LF is additionally provided.

Initially, the blackboard LF is unaware of the service SERV, since, by way of example, the service provider has not yet been integrated into the ad-hoc network. When the service SERV has been integrated, it is detected by the discovery function DF. Subsequently, in accordance with one variant of the invention, an inventive check C_{EF} is carried out by comparing the detected service SERV with checking data stored in the database DB. By way of example, the identity of the service provider SP, having an authentication WHO, is checked against the authentication database WHO-DB, and/or the authorization of the service provider, having an authorization WHAT, to register the service SERV on the blackboard is checked using the authorization database WHAT-DB. If [lacuna], the authorization database WHAT-DB contains data for stipulating user groups. In that case, not only individual users but also the members of groups are entitled to use RMI the service SERV. In this context, which users and groups are entitled to which services SERV is specified in the authorization database WHAT-DB. Provided that the check C_{EF} reveals that subsequent use RMI of the service SERV is admissible, the service SERV is entered into the list of admissible services LoCS.

In accordance with one embodiment of the present invention, following the optional check C_{EF}, the use interface STUB for the service SERV is loaded using a loading operation LOAD and is stored on the blackboard LF; e.g., in the list of admissible services LoCS. According to the present invention, in this context, the loaded use software STUB is at least partially extended by a security function SEC. In accordance with one embodiment of the present invention, this extension is made by the extension function EF. Preferably, this extension is made only if the check C_{EF} reveals that use RMI of the service SERV is admissible.

The service SERV can be used RMI by the service user SU as soon as the service user SU has been integrated into the ad-hoc network. Subsequently, an inquiry with the blackboard LF can be used to detect that the service SERV can be used in this ad-hoc network. To this end, the service user SU loads the extended use software STUB (SEC) stored on the blackboard LF. It is then run; e.g., using a virtual machine JVM which is already installed. This provides for use RMI of the service SERV by the service user SU.

In accordance with another embodiment of the present invention, in this context, the complemented security function SEC carries out a check C_{SEC} on the authentication WHO and/or authorization WHAT of the service user SU; e.g., whenever the service SERV is used RMI. It is, thus, possible to ensure that there is no unauthorized use RMI; e.g., by interface calls copied or manipulated by unauthorized third parties.

Finally, the illustrative character of this physical arrangement will be emphasized. Any other desired distribution of the function over the physical system is possible. Thus, the blackboard LF could, by way of example, also be integrated into the printer PRT, could be provided on the laptop LAP or could be run in a mobile phone. The database DB could be integrated into a security database (e.g., user management in a network domain) also used for other security procedures. This largely arbitrary configuration of the system is shown in FIG. 1 by illustrating the physical devices in dashed lines.

In addition, it may be pointed out that the present invention is not limited to ad-hoc networks AHN but, rather, may be used in any desired communication network in which PnP concepts using blackboards LF are used. By way of example, use is envisaged in:

long distance communication networks, such as the Internet;

local communication networks, also called “local area networks” or “LANs”; and

virtual communication networks, such as a virtual private network (“VPN”).

Indeed, although the present invention has been described with reference to specific embodiments, those of skill in the art will recognize that changes may be made thereto without departing from the spirit and scope of the invention as set forth in the hereafter appended claims.

I claim as my invention:

1. A method for the secure use of a network service with use software, the method comprising the steps of:
extending the use software by at least one security function to form at least partially secure extended use software; and
using the service by using the extended use software.

2. A method for the secure use of a network service with use software as claimed in claim 1, wherein the extension is made by an extension function associated with a blackboard.

3. A method for the secure use of a network service with use software as claimed in claim 1, wherein the extended use software is stored on a blackboard from which it is loaded by a service user at least before the service user uses the service for the first time.

4. A method for the secure use of a network service with use software as claimed in claim 3, wherein the storage on the blackboard is effected only if a check reveals that storage is admissible.

5. A method for the secure use of a network service with use software as claimed in claim 4, wherein the check includes at least one of authentication and authorization of a service provider providing at least one of the service and the use software.

6. A method for the secure use of a network service with use software as claimed in claim 4, wherein the extension is made if the check reveals that use of the service is admissible.

7. A method for the secure use of a network service with use software as claimed in claim 1, wherein at least one of the use software and the extended use software has a format which is executed by a virtual machine.

8. A method for the secure use of a network service with use software as claimed in claim 1, wherein the security function includes at least one of the authentication and the authorization.

9. A method for the secure use of a network service with use software as claimed in claim 8, wherein, in the context of the security function, the authentication checks an identity of the service user and the authorization checks entitlements of the service user.

10. A method for the secure use of a network service with use software as claimed in claim 8, wherein, in the context of the authorization, different groups of service users having different use entitlements are provided.

11. A method for the secure use of a network service with use software as claimed in claim 1, wherein the security function is carried out whenever the service is used.

12. A system for the secure use of a network service, comprising:
a communications network on which the network service is available;
use software associated with the network service; and
a part for extending the use software by at least one security function to form at least partially secure use software, wherein the service is used by using the extended use software.
